(19) United States
(12) Patent Application Publication
(10) Pub. No.: US 2026/0319790 A1
(43) Pub. Date: Oct. 15, 2026

(54) CODE REVIEW COMMENT GENERATION VIA INSTRUCTION PROMPTING WITH INTENT

(71) Applicant: Microsoft Technology Licensing, LLC, Redmond, WA (US)

(72) Inventors: Shengyu FU, Redmond, WA (US); Neelakantan SUNDARESAN, Bellevue, WA (US); Alexey SVYATKOVSKIY, Bellevue, WA (US); Shuo ZHANG, Issaquah, WA (US)

(21) Appl. No.: 19/706,981

(22) Filed: Jun. 12, 2026

Related U.S. Application Data
(63) Continuation of application No. 18/372,059, filed on Sep. 23, 2023.

(51) Int. Cl. G06F 8/73; G06F 8/41; G06F 40/30

(52) U.S. Cl. CPC G06F 8/73; G06F 8/433; G06F 40/30

(57) ABSTRACT

A code review is automatically generated by a large language model given a prompt that includes code changes made to a source code program, an associated intent, and an extended context. The intent represents an issue with the code changes from a code reviewer's perspective and is predicted from a neural classifier given the code changes in a code diff format. The neural classifier is a neural encoder transformer model pre-trained on various code review datasets and fine-tuned on code diff hunks of code changes labeled with an intent.

### CROSS-REFERENCE TO RELATED APPLICATIONS

This application is a continuation of U.S. patent application Ser. No. 18/372,059 filed on Sep. 23, 2023, entitled “CODE REVIEW COMMENT GENERATION VIA INSTRUCTION PROMPTING WITH INTENT,” which application is expressly incorporated herein by reference in its entirety.

### BACKGROUND

Code or peer review is a process that is often utilized during software development where the source code under development is reviewed by one or more peers of the author of the source code. The source code is often inspected to discover errors, to ensure that the source code complies with best practice standards and to discover vulnerabilities, such as race conditions, malware, memory leaks, buffer overflows, format string exploits, and the like. Code review is used to find these problems which may have been overlooked in the development of the source code before the software is released.

Code review is often performed manually requiring a peer to spend a significant amount of time to understand the source code program and to review the source code. Code review requires a peer to understand the source code program's logic, functionality, style and other factors. When the code review process is performed manually, it is subject to human errors. The peer reviewer may miss very obvious errors in the source code or waste time reviewing and commenting on source code not in error.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A code review comment is predicted by a large language model (LLM) given code changes made to a source code program, an intent associated with the code changes, and an extended context extracted from the source code program. The intent is predicted from a classifier model given the code changes. The intent classifier model maps a set of code changes with an intent that represents an issue with the code changes based on historical code review comments for similar code changes. The intent guides the large language model towards generating a more accurate code review comment.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary system for generating a code review comment using a large language model given a prompt including a predicted code reviewer's intent.

FIG. 2 is a schematic diagram illustrating an exemplary prompt for a large language model to generate a corresponding code review comment.

FIG. 3 is a schematic diagram illustrating the training of the intent classification model.

FIG. 4 is a schematic diagram illustrating an exemplary architecture of a pre-trained deep learning model as a neural transformer model with attention in an encoder-decoder configuration.

FIG. 5 is a schematic diagram illustrating an exemplary configuration of the intent classification model as a neural encoder transformer model with attention.

FIG. 6 is a flow diagram illustrating an exemplary method for generating the intent classification model.

FIG. 7 is a flow diagram illustrating an exemplary method for generating a prompt to a large language model for a code review comment.

FIG. 8 is a schematic diagram illustrating usage of the code review generation system in a version-controlled source code repository.

FIG. 9 is a block diagram illustrating an exemplary operating environment.

### DETAILED DESCRIPTION

### Overview

Aspects of the present disclosure pertain to the automation of a code review comment for code changes made to a distributed source code program using a large language model. The large language model predicts a code review comment for the code changes given a prompt that includes a natural language description of the code review generation task, the code changes in a code diff hunk format, and a likely intent of a code reviewer and a context of the code changes.

Code review is a process that is often part of a version-controlled source code repository. A version-controlled source code repository manages changes to the files of a file system. Each developer obtains a full copy of the files in the repository in their own branch. The original code is typically stored in a master branch in a separate computing device. The developer makes changes to their version of a file of the repository. The change to the file is noted in a commit. Before a change is merged back into the original file, the change is reviewed using the code review process.

The code review process is initiated from issuance of a pull request. A pull request is a request to merge one or more commits into a different branch of the repository, such as the master branch. A code reviewer reviews the changes and provide comments or suggestions otherwise referred to herein as the code review comment. The code review comment may include source code, natural language text, and/or a combination thereof. The developer may make additional changes to the code based on the comments submitted by the code reviewer. The pull request is then approved and the changes are merged into the main branch of the source code repository or discarded.

The code reviewer's comment often identifies an issue with the proposed code changes. The intent is from the code reviewer's perspective and it is what a code reviewer would perceive as the issue or problem with the proposed code changes. The intent may identify a source code bug, the need for code cleanup, the need for code formatting, a problem with a configuration of files, and others.

A large language model is used to predict a code review comment for a set of code changes. The large language model is a type of neural-based machine learning model trained on a massively-large training dataset of text and/or source code resulting in the model containing billions of parameters. Due to its extensive training, the large language model has an extensive capability to perform various tasks such as natural language processing, text generation, machine translation, and source code generation.

The large language model is typically given a user prompt that consists of text in the form of a question, an instruction, short paragraph and/or source code that instructs the model to perform a task and optionally, format of the intended response. In order for the large language model to make a prediction for a task that it has not been trained on or to make a prediction on input not seen during training, the prompt to the model includes the intent of the code changes. The inclusion of the intent guides the model towards generating a more accurate code review. The intent serves as a clear direction to the large language model of what aspect it should find issues from. For example, finding issues in code formatting, or logic, or some other aspect. This intent helps the large language model to narrow down the range of the potential issues resulting in a more accurate code review comments and suggestions.

The code reviewer's intent is not something that is readily apparent from the code changes. The intent is predicted from a machine learning model that is trained to learn to predict an intent from historical data consisting of various code changes with a labeled intent.

Each intent is represented as a class and the machine learning model learns to classify a given code change with a particular intent based on a probability generated by the machine learning model. The predicted intent is then used in the prompt for the large language model to guide the model towards generating a more accurate code review comment.

Attention now turns to a more detailed description of the components, methods, processes, and system for automating code review comments.

### System

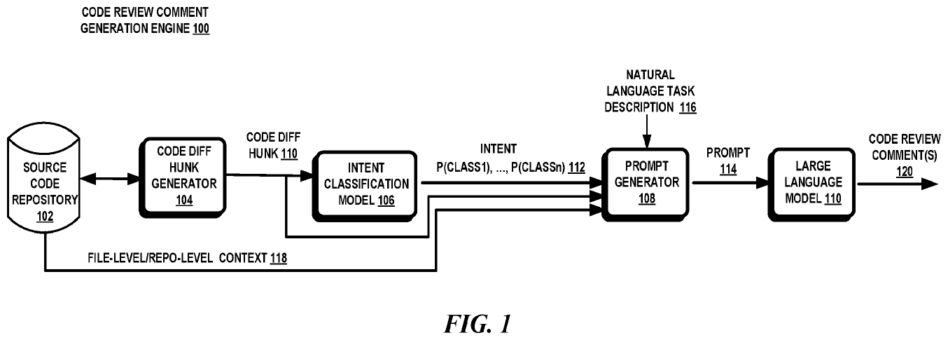

FIG. 1 illustrates a block diagram of an exemplary system 100 for generating code review comments using a large language model given a prompt that includes the code changes made to a source code program, a corresponding intent, and a context. In addition, the prompt includes a natural language description of the code review generation task.

In an aspect, the system 100 includes a source code repository 102, a code diff hunk generator 104, an intent classification model 106, a prompt generator 108, and a large language model 110. The source code repository 102 may be a file archive and web hosting facility that stores large amounts of source code either privately or publicly or a project associated with an integrated development environment. The source code repository 102 can be structured as a in version control system, such as GIT, Mercurial, etc. The source code programs residing in the source code repository 102 vary and may be written in different programming languages.

The code diff hunk generator 104 extracts source code having been changed and formats the changed code in a code diff format. The code diff format shows the changes between two files, such as the original source code and the revised version of the original source code, in sequences of lines common to both files, interspersed with groups of differing lines. A code diff hunk 110 is a sequence of changed source code lines, including deleted lines, surrounded by a few unchanged lines or context. The code diff format is an efficient representation of the code changes since the unchanged lines occur only once. The code diff format includes diff characters at the beginning of each line. The diff characters denote changes with “−” and “+” tags and no changes with a blank space. The code diff hunk is a compact and convenient format for showing the code before and the code after the change which includes the editing steps at a given granularity, such as at the line level. As such, the code diff hunk is a more natural way for model learning instead of training the model with raw source code.

The code diff hunk generator 104 receives the pull requests, commits, and source code files, extracts the relevant code changes and formats them into a code diff hunk 110. The code diff hunk generator 104 replaces each of the diff characters, (e.g., ‘+’, ‘−’, and blank space) in a code diff hunk 110 with a corresponding special token. The ‘+’ character is replaced with the add token, [ADD], the ‘−’ character is replaced with the delete token, [DEL], and the blank space character is replaced with the [KEEP] token.

The intent classification model 106 receives the code diff hunk 110 and predicts an intent. The intent classification model is a neural classifier, such as a neural encoder transformer with attention. The neural encoder transformer with attention is trained on a large scale of unsupervised data derived from various code review tasks that include edits of changed code with and without code review comments. The intent classification model classifies the code diff hunk into one of several intents.

In an aspect, the intents include one or more of the following: NULL_HANDLING: check whether the value of a variable could potentially be null and handle it properly; CODE_FORMAT_LINES: format code according to best programming practices; CODE_REFACTOR_RENAME: whether the code could be refactored, or a variable could have a more readable and meaningful name; UNIT_TESTING: check whether a unit test should be written for a newly added function, or find any logical issue within a unit test; CONFIG-whether a configuration is handled properly; FILES_PATHS: check whether a file path has correct format and is being handled properly; CHECK_VERIFY_LOGIC: check and verify programming logic; EXCEPTION_HANDLING_LOG_ERROR: whether the correct exception can be caught, should the exception be more detailed, has the error been properly handled and logged; CODE_CLEANUP: clean up tedious or unused code, simpler implementation of the logic; DATETIME_TIME_DURATION: whether a date, time or duration is handled properly; STATIC_CONSTANT_IMPORT: whether a declaration should be static, literals could be defined as constants, any issues in import statements such as import order, outdated import, and unused import; STRING_OPERATIONS: check whether a string operation is correct, or is there a simpler way to do the string operation such as using regular expression; and THREAD_LOCK_SLEEP: check potential issues in multithreading such as thread locking/sleep and synchronization.

The prompt generator 108 creates a prompt 114 using several inputs: the predicted intent 112, a code diff hunk 110, a context 118, and a written task description in natural language 116. The prompt 114 contains a clear explanation of the task of generating prompts, the actual changes made in the code diff hunk, the intent behind the changes, an overview of the file where the change is happening, and any pertinent context from the entire repository.

The context 118 includes a file-level context and/or a repository-level context. The file-level context includes import statements, global attributes, the signature of the class where the change occurs, methods that are adjacent to or directly invoked in the area of change, method signatures of other methods in the file. The repository-level context includes method signatures used in the source code program that are defined in other files in the same repository.

To gather the file-level context of the specific file, the file is parsed into a syntax tree. The syntax node of the tree of the suggested code alteration is identified. This is figured out based on the line range provided in the code diff hunk. After this, the process involves selecting the most important syntax structures from the entire file. This selection prioritizes elements like import statements, global attributes, the signature of the class where the change occurs, methods that are adjacent to or directly invoked in the area of change. For other methods in the file, only their signatures are retained. Incorporating this file-level and repo-level context equips large language models to fully understand the nature of the code modification, leading to fewer errors and more accurate predictions.

The large language model 110 returns one or more code review comments 120 for the given prompt 114. In an aspect, the large language model 212 is a neural transformer model with attention. A neural transformer model with attention is one distinct type of machine learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models are one type of deep learning that utilizes an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN).

There are various configurations of a neural transformer model with attention. In an aspect, the large language model is configured as an encoder-decoder neural transformer model with attention having a series of stacked encoder blocks coupled to a series of stacked decoder blocks. In another aspect, the large language model consists only of stacked decoder blocks. In addition, the large language model may be trained to perform different tasks and/or may be configured in different model sizes (i.e., different number of parameters).

In an aspect, the large language model is pre-trained on natural language text and source code. The training of a large language model requires a considerable amount of training data and computing resources which makes it impossible for some developers to create their own models. The large language model consists of billions of parameters (e.g., weights, biases, embeddings) from being trained on terabytes of data. Examples of the large language models include the conversational pre-trained generative neural transformer models with attention offered by OpenAI i.e., ChatGPT and Codex models, PaLM and Chinchilla by Google, and LLaMa by Meta.

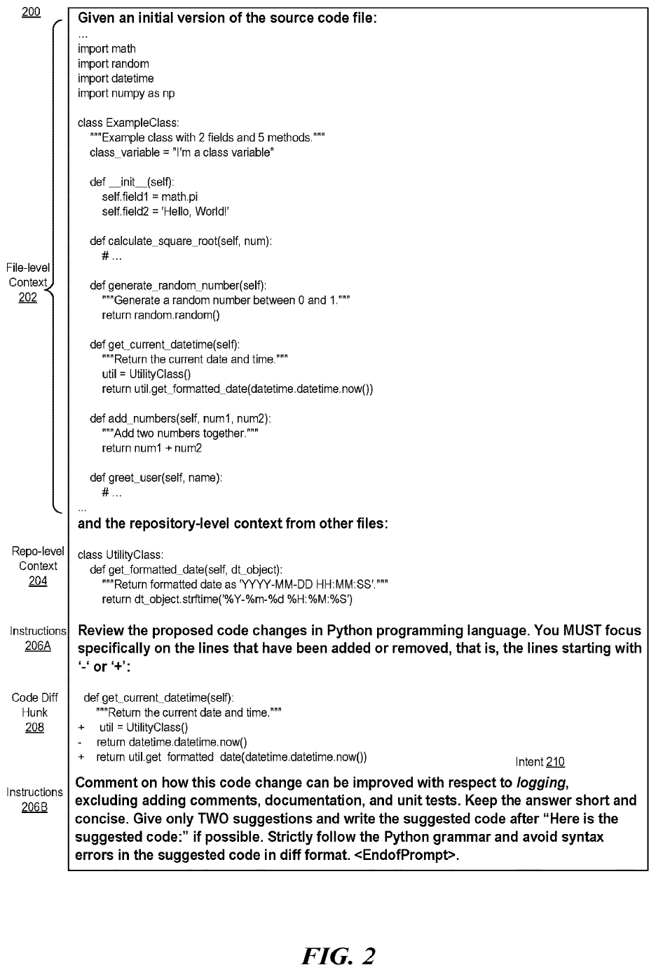

FIG. 2 illustrates an exemplary prompt 200. The prompt 200 is for the generation of a code review comment for a code change to the method or function, get_current_datetime, written in the Python programming language. The prompt 200 includes the natural language instructions 206A-206B which are as follows: “Given an initial version of the source code file . . . and the repository-level context from other files. . . . Review the proposed code changes in Python programming language. You MUST focus specifically on the lines that have been added or removed, that is, the lines starting with ‘−’ or ‘+’; . . . . Comment on how this code change can be improved with respect to logging, excluding adding comments, documentation, and unit tests. Keep the answer short and concise. Give only TWO suggestions and write the suggested ode after “Here is the suggested code:” if possible. Strictly follow the Python grammar and avoid syntax errors in the suggested code in diff format.”

The file-level context 202 includes the import statements, import math, import random, import datetime, import numpy as np, the signature of the class where the change occurs, ExampleClass, methods that are adjacent to or directly invoked in the area of change, get_current_datetime, method signatures of other methods in the file, def _init_, def calculate_square_root, def generate_random_number, def get_current_datetime, def add_numbers, def greet_user.

The repo-level context 204 includes the signature of the class UtilityClass containing the method signature, def get_formatted_date, which is included in the code change.

The code diff hunk 208 includes the code changes in the code diff format. The intent 210 is logging which is the process of keeping track of events that occur with the operating system or application when executed.

### Training of Intent Classification Model

Attention now turns to the training of the intent classification model. The intent classification model is generated by fine-tuning the encoder portion of a pre-trained encoder-decoder deep learning model. A deep learning model is pre-trained on a large-scale of unsupervised code review training dataset derived from different code review tasks. The pre-trained deep learning model learns the relationships between changed source code and code review comments from training on unsupervised pre-training datasets that include denoising code diff tags, denoising code diffs, denoising code reviews and pairs of changed code with an associated review comment.

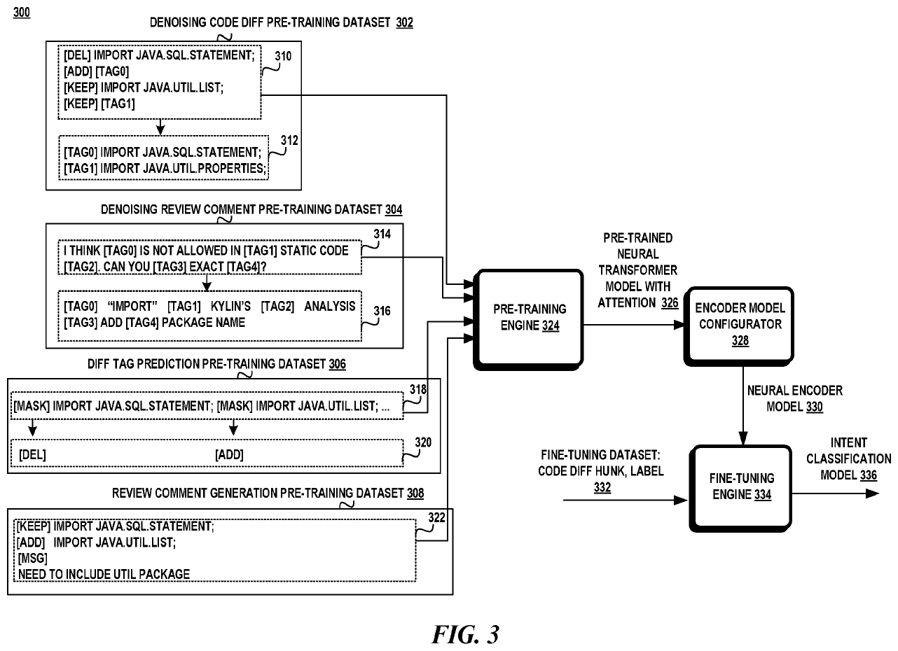

Turning to FIG. 3, there is shown a schematic diagram of the training of the pre-trained deep learning model 300. In an aspect, the deep learning model is a neural transformer model with attention configured with stacked encoder blocks coupled to stacked decoder blocks. The pre-trained model 326 is pre-trained using a denoising code diff pre-training dataset 302, a denoising review comment pre-training dataset 304, a diff tag prediction pre-training dataset 306, and a review comment generation pre-training dataset 308 input into the pre-training engine 324.

The denoising code diff pre-training dataset 302 consists of pre-training samples of code changes based on a diff format with spans of code lines masked 310. The deep learning model is trained to learn to predict the tokens to replace the masked lines of code. As shown in box 310, there are two lines of code that are replaced with masked tokens, [TAG0], [TAG1]. The model is trained to learn to predict the source code lines to replace these masked tokens. As shown in box 312, the source code line Import Java.Sql.Statement replaces the mask token [TAG0] and the source code line Import Java.Sql.Util.Properties replaces the mask token [TAG1].

The denoising review comment pre-training dataset 304 consists of training samples of code review comments having masked tokens, [TAG0], [TAG1], [TAG2], [TAG3], [TAG4] 314. The deep learning model is trained to learn to predict the tokens to replace the masked tokens. As shown in box 316, the token Import replaces the token [TAG0], the token Kylin's replaces the [TAG1] token, the token Analysis replaces the token [TAG2], the token Add replaces the [TAG3] token, and the token Package Name replaces the token [TAG4].

The diff tag prediction pre-training dataset 306 consists of diff tag prediction pre-training samples of code changes having masked special tokens. The deep learning model is trained to learn to predict the special token to replace the masked special token in a particular position. As shown in box 318, there is shown a code change in a diff-format with masked tokens, [MASK], which the model is trained to replace with a respective special token, [DEL], [ADD], for each respective position 320.

The pre-training engine 324 receives each pre-training sample of each pre-training dataset and transforms each pre-training sample into an input embedding sequence that is input into the deep learning model. There is no particular order in which the pre-training datasets are input to train the deep learning model. Upon completion of the pre-training, the pre-training engine may test and validate the deep learning model to meet specific performance targets.

In the pre-training of the deep learning model, the deep learning model learns to understand source code and natural language text, the relationship between the different code elements and natural language text, and the syntax of a programming language and natural language text. The weights of the model (e.g., token/subtoken embeddings, attention weights (K,V,Q), neural weights and biases) are initialized randomly and changed during pre-training based on the samples in the pre-training dataset. The weights of the model are optimized based on reducing a cost function of the neural network layers. The pre-training engine 324 uses the pre-training dataset of unsupervised pre-training datasets to pre-train the model for the optimal weights.

Upon completion of the pre-training, the encoder model configurator 328 configures a neural encoder transformer model with attention 330 with the encoder blocks from the pre-trained model. During fine-tuning, the weights computed from the pre-training are used as the initial weights and tuned by the fine-tuning engine 334 for the fine-tuning task. The fine-tuning engine 334 uses a fine-tuning dataset 332 composed of code diff hunks and corresponding labels that identify the intent associated with a code diff hunk. Upon completion of the fine-tuning, the intent classification model 336 is produced.

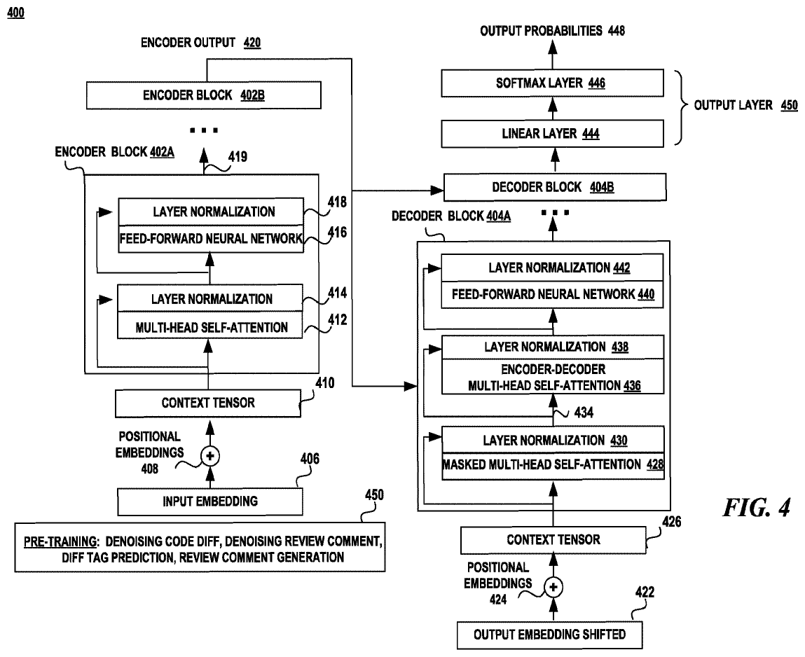

FIG. 4 shows an exemplary structure of the pre-trained neural transformer model with attention in an encoder-decoder configuration. The neural transformer model 400 contains one or more encoder blocks 402A, 402B coupled to one or more decoder blocks 404A, 404B. The initial inputs to an encoder block 402 are the input embeddings 406 of an input sequence of a pre-training dataset, fine-tuning dataset, or inference data. In order to retain the order of the tokens in the input embedding 406, positional embeddings 408 are added to the input embedding 406 forming a context tensor 410. The initial inputs to the first decoder block 404A are a shifted sequence of the output embeddings 422 from a previous time step to which the positional embeddings 424 are added forming context tensor 426.

An encoder block 402A, 402B consists of two layers. The first layer includes a multi-head self-attention component 412 followed by layer normalization component 414. The second layer includes a feed-forward neural network 416 followed by a layer normalization component 418. The context tensor 410 is input into the multi-head self-attention component 412 of the first encoder block 402A with a residual connection to the layer normalization component 414. The output of the layer normalization component 414 is input to the feed-forward neural network 416 with another residual connection to layer normalization component 418. The output of the encoder block 402 is a set of hidden representations 419. The set of hidden representations 419 is then sent through additional encoder blocks. At the last encoder block, the set of hidden representations 420 is sent to the decoder 404.

Attention is used to decide which parts of the input embedding are important for each token, especially when decoding long sequences since the encoder is limited to encoding a fixed-size vector. Attention mechanisms gather information about the relevant context of a given token and then encode that context into a vector which represents the token. It is used to identity the relationships between tokens in the long sequence while ignoring other tokens that do not have much bearing on a given prediction.

The multi-head self-attention component 412 takes a context tensor 410 and weighs the relevance of each token represented in the context tensor 410 to each other by generating attention weights for each token in the input embedding 406. In one aspect, the attention function is scaled dot-product attention which is described mathematically as follows:

$$Attention ( Q , K , V ) = softmax ( \frac{{QK}^{T}}{\sqrt{{d}_{k}}} ) V ,$$

where the input consists of queries Q and keys K of dimension dₖ, and values V of dimension dᵥ, Q is a matrix that contains the query or vector representation of one token in a sequence, K is the vector representations of all tokens in the sequence, and V is the vector representations of all the tokens in the sequence.

The queries, keys and values are linearly projected h times in parallel with dᵥ output values which are concatenated to a final value:

MultiHead(Q,K,V)=Concat(head₁, . . . ,headₕ)W^{o},
where headᵢ=Attention(QWᵢ^{Q}, KWᵢ^{K}, VWᵢ^{V}),
with parameter matrices Wᵢ^{Q}ϵ [symbol] Wᵢ^{K}ϵ [symbol] , Wᵢ^{V}ϵ [symbol] , and W^{O}ϵ [symbol] .

In order to reduce the training time of the neural transformer, layer normalization is used between the layers. The layer normalization components 414, 418 normalize the inputs across the features. The mean and standard deviation is computed across the feature dimensions.

The feed-forward neural network 416 processes each output encoding separately. The output of the top encoder block is a set of attention vectors K and V 420 which is used by the encoder-decoder multi-head self-attention layer 436 of the decoder block 404.

The decoder block 404A, 404B predicts each token tᵢ in the target programming language one-by-one at each time step conditioned on all previously-generated target tokens t₁, . . . tᵢ₋₁. A decoder block 404A, 404B consists of three layers. The first layer includes a masked multi-head self-attention component 428 followed by a layer normalization component 430. The output of the layer normalization component is input into the encoder-decoder multi-head attention component 436 with a residual connection to layer normalization component 438. The second layer includes an encoder-decoder multi-head self-attention component 436 followed by a layer normalization component 438. The third layer includes a feed-forward neural network 440 followed by a layer normalization component 442. The output of layer normalization component 442 is input into the feed-forward neural network 440 with a residual connection to layer normalization component 442.

The masked multi-head self-attention component 428 receives the output embeddings of the previous timestep. The masked multi-head self-attention component 428 masks the output embeddings from future time steps. The encoder-decoder multi-head self-attention layer 428 receives queries from the previous decoder layer and the memory keys and values 420 from the output of the last encoder block 402. In this manner, the decoder block 404 can attend to every position of the input sequence. The feed-forward neural network 440 processes each output encoding separately. A layer normalization component 430, 438, 442 is used between the layers in order to normalizes the inputs across the features.

In one aspect, the neural transformer model contains a stack of twelve encoder blocks and a stack of twelve decoder blocks which are aggregated into a neural transformer block. The output of each encoder block is passed onto the next encoder block and processed. Each decoder block receives the attention weights computed from the last encoder block. The use of multiple stacked encoder blocks and decoder blocks increases the model's capacity allowing the model to learn increasing levels of abstraction.

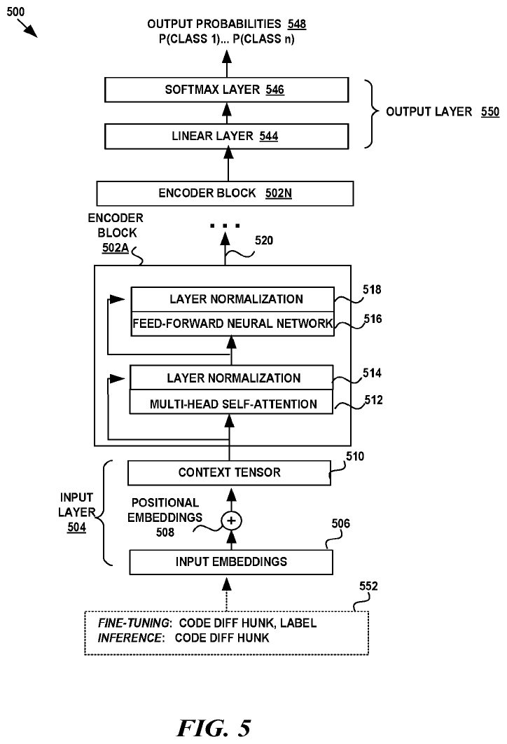

Turning to FIG. 5, there is shown a configuration 500 of the encoder portion of the fine-tuned deep learning model. The structure of the encoder shown in FIG. 5 is similar to the structure of the encoder in the pre-trained deep learning model shown in FIG. 4 except for the output layer 550. The encoder 500 includes one or more encoder blocks 502A, 502N where each encoder block contains two layers. The first layer includes a multi-head self-attention component 512 and a layer normalization component 514 and the second layer includes a feed-forward neural network 516 and a layer normalization component 518. The input layer 504 includes an input embedding 506 combined with its positional embeddings 508 to form a context tensor 510.

The input embeddings 506 represent an input sequence applied to the deep learning model 500. During fine-tuning, the input embeddings represent a code diff hunk and a corresponding label 552. The label represents one of the classes. During inference, the input embeddings represent a code diff hunk 552.

The structure of the encoder 500 differs from the configuration shown in FIG. 4 since the output of the last encoder block 502N goes into an output layer 550 that includes a linear layer 544 and a softmax layer 546. The linear layer 544 is a neural network that receives the unscaled output of the last encoder block and turns them into log its. A log it is an unnormalized prediction of the feed-forward output from the last encoder block.

The softmax layer 546 applies the softmax function to the log its of the linear layer to approximate a probability distribution having multiple classes, Class 1 and Class N 548. The output probabilities, P(Class 1), . . . , P(Class N), indicate the likelihood that the given code diff hunk is associated with a particular intent.

### Methods

Attention now turns to a more detailed description of the methods used in the system for code review generation. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

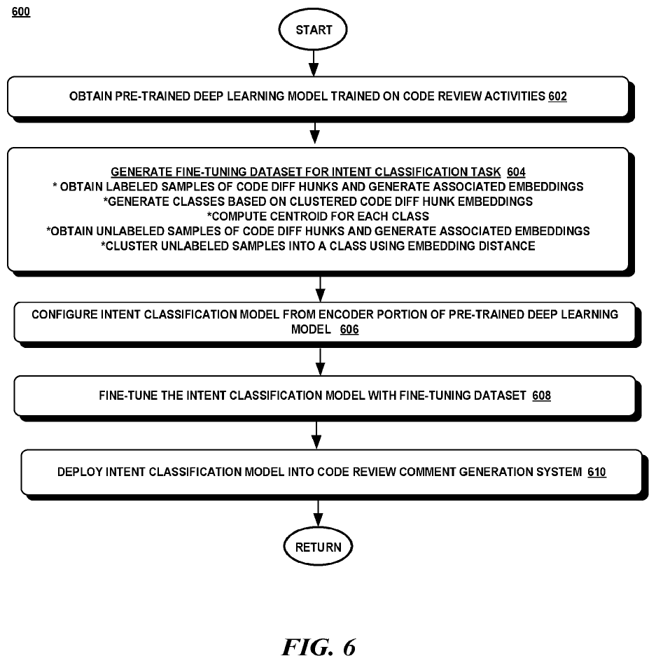

FIG. 6 illustrates an exemplary method for generating the intent classification model. Initially, a pre-trained deep learning model trained on code review tasks is obtained (block 602). Alternatively, the pre-trained deep learning model may be created using the pre-training datasets described above (block 602).

The fine-tuning datasets for the intent classification task are generated (block 604). Samples of code diff hunks are obtained which contain a labeled intent. An embedding is generated for each labeled code diff hunk. The embedding is generated by an encoder and is a mapping of a discrete categorical variable to a vector of continuous numbers. The embeddings of the labeled code diff hunks are clustered into groups based on a closest similar embedding distance. Each group includes a centroid which is the geometric center or arithmetic mean of the group. Each group represents a particular intent or class.

Additional samples are obtained of code diff hunks that are not labeled. An embedding is generated for each unlabeled code diff hunk. The unlabeled code diff hunk is then placed into the group having a centroid with the closest distance to the embedding of the unlabeled code diff hunk. (Collectively, block 604).

The encoder portion of the pre-trained deep learning model is then configured as the intent classification model (block 606) and fine-tuned with the fine-tuning dataset (block 608).

Neural transformer models are trained iteratively, making multiple passes over the training dataset before converging to a minimum. An epoch represents the entire pre-training dataset passed forwards and backwards through the neural encoder transformer blocks once. Since the training dataset is very large, it is partitioned into smaller batches. The training is iterative and the entire training dataset is passed through the neural transformer with attention in multiple iterations. Each training iteration includes forward propagation, loss calculation, backpropagation steps followed by updating the weights. The training dataset is partitioned into batches with each batch of sequences running through the pre-training process. (Collectively, block 608).

For each input sequence of each batch in each epoch, the T-ordered sequences of tokens are then mapped into numeric vectors and then into respective token embeddings and positional embeddings. Initial values for the token embedding and positional embeddings of each input sequence come from the pre-trained deep learning model. Thereafter, the neural transformer model updates the values for each embedding through backpropagation. (Collectively, block 608).

Upon the completion of the training phase, the embeddings for each token and the positional embeddings are saved into respective matrices for later use. There is a token embedding matrix, We, that contains an embedding vector for each token tᵢ, i=0 . . . V of a particular programming language, and a positional embedding matrix, Wp, that contains an embedding vector Pⱼ, j=0 . . . T, for each position, where V is the size of the model vocabulary and T is the length of the token sequence. (Collectively, block 608).

The feed forward neural networks in the encoder blocks are trained iteratively, making multiple passes over the training dataset before converging to a minimum. Each training iteration includes forward propagation, loss calculation, backpropagation steps followed by updating the weights by calculating the weight gradients. The loss function estimates the loss or error which is used to compare how good or bad the predicted results are. In one aspect, a categorical cross-entropy loss function is used. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation through time (BPTT) algorithm may be used to update the weights. (Collectively, block 608).

Upon the completion of the training and validation of the intent classification model, the model is deployed into a code review comment generation system (block 610).

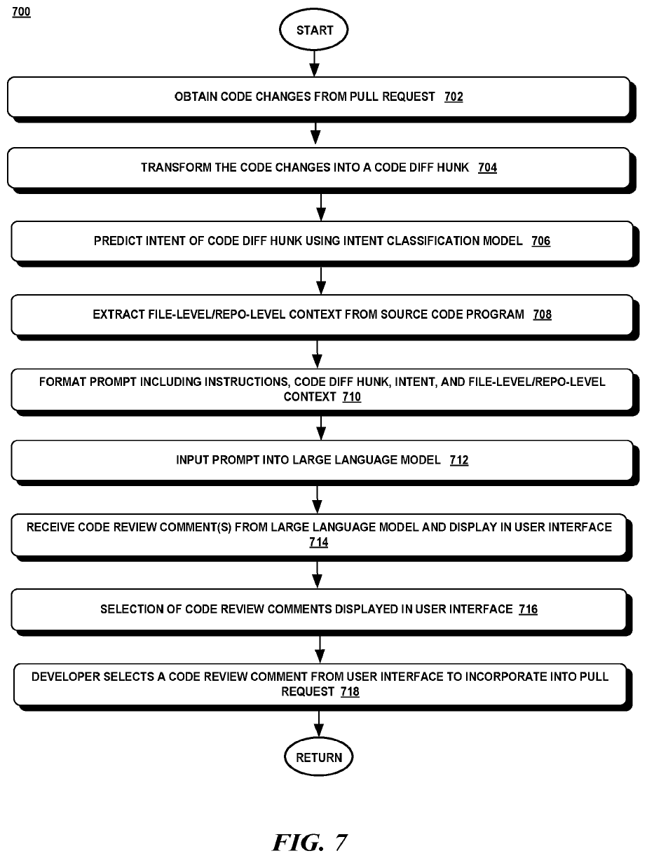

Attention now turns to a more detailed discussion of the generation of a code review comment using the code review generation engine. FIG. 7 illustrates an exemplary method of the inference process of the code review comment generation engine.

Code changes from a pull request are obtained (block 702). The code changes are transformed into a code diff hunk (block 704) and the code diff hunk is input into the intent classification model (block 706). The intent classification model outputs a probability distribution for a set of classes. The intent is predicted as the class having the highest probability (block 706).

The file-level and repo-level context is extracted from the source code program having the code changes (block 708). The prompt generator then constructs the prompt with a natural language description of the task, code diff hunk of the code changes, the intent, and the file-level and repo-level context (block 710). The prompt is applied to the large language model (block 712) and one or more code review comment candidates are predicted by the large language model (block 714).

In an aspect, the code review comment candidates are displayed in a user interface of an inference system for a code reviewer to select from (block 716). The selected code review comment is then input into the pull request for the developer having made the changes to review (block 718).

### Operating Environments

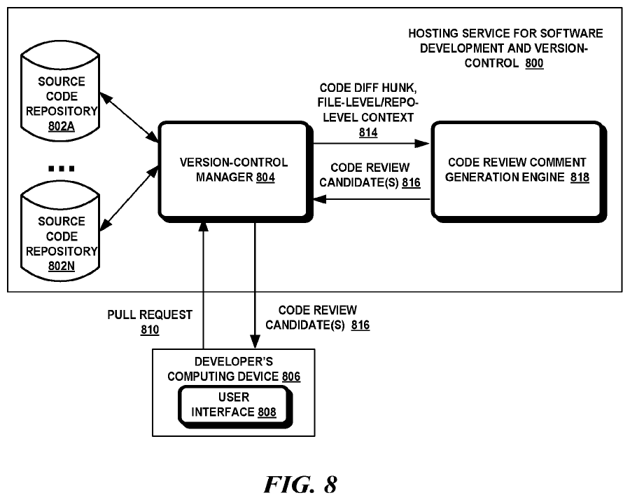

Attention now turns to a description of an exemplary system employing the code review comment generation engine. Turning to FIGS. 1 and 8, there is shown a hosting service for software development and version control 800. The hosting service 800 may be a web service accessed through a network, such as the Internet. The hosting service 800 includes one or more source code repositories 802A-802N (“802”), a version-control manager 804, and the code review engine 818. The source code repositories 802 store source code files, documents and other data. The version-control manager 804 tracks and manages changes made to the files of the source code repositories 802.

The hosting service 800 interacts with a developer's computing device 806 having a copy of a source code file stored in one of the source code repositories. A developer via the developer's computing device 806 may initiate a pull request 808 to commit changes back to a version of the source code file stored in the hosting service. The version-control manager 804 initiates a request to the code review engine 818 for a code review comment for the changed code of the pull request. The version-control manager 804 generates a code diff hunk and extracts a file-level and repo-level context 814, which is sent to the code review comment generation engine 818. The code review comment generation engine 818 generates one or more code review comment candidates 816 which are sent to the developer 806 and displayed in the user interface 808. The developer may submit additional pull requests including additional changes and eventually the changes are merged into the source code file of the hosting service.

The code review engine 818 includes the code diff hunk generator 104, the intent classification model 106, the prompt generator 108 and the large language model 110. In an aspect, the large language model may be hosted on a remote server. In an aspect, the remote server hosting the large language model and the computing device hosting the code review engine 818 communicate through HTTP-based Representational State Transfer (REST) Application Programming Interfaces (API). A REST API or web API is an API that conforms to the REST protocol. In the REST protocol, the remote server hosting the large language model contains a publicly-exposed endpoint having a defined request and response structure expressed in a JavaScript Object Notation (JSON) format. The code review engine issues web APIs containing the prompt to the remote server to instruct the large language model to perform the intended task.

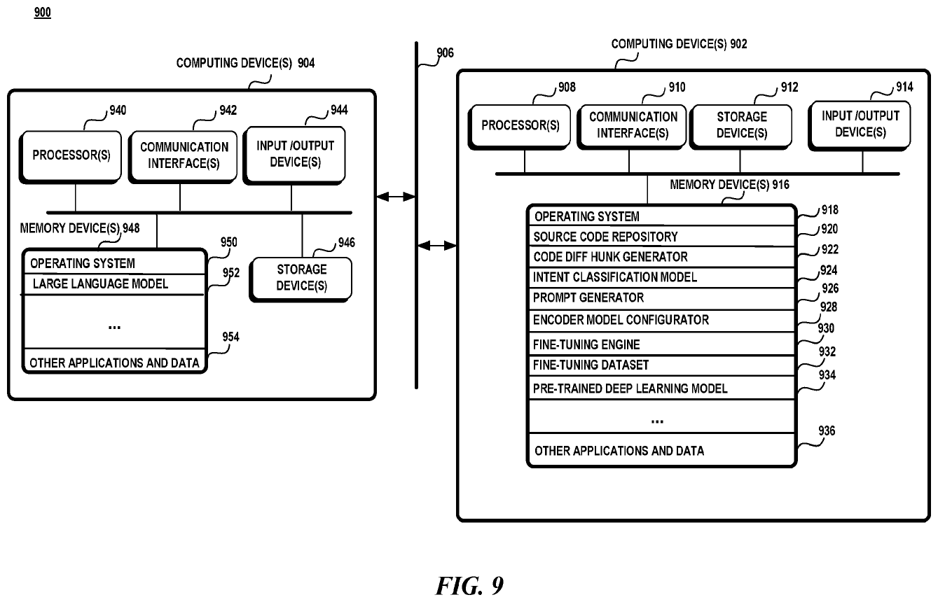

Attention now turns to a discussion of a second exemplary operating environment 900. FIG. 9 illustrates an exemplary operating environment 900 having one or more computing devices 902, 904 communicatively coupled to a network 906. In one aspect, the generation of the prompt and the creation of the intent classification model may be processed on one computing device 902 and the large language model may be hosted as a service on a second computing device 904. In another aspect, the creation of the intent classification model may be hosted on another computing device or with the service hosting the large language model. The aspects of the operating environment are not constrained to a particular configuration.

The computing devices 902, 904 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 900 may be configured in a network environment, a distributed environment, a multi-processor environment, or a stand-alone computing device having access to remote or local storage devices.

A computing device 902, 904 may include one or more processors 908, 940, one or more communication interfaces 910, 942, one or more storage devices 912, 946, one or more input/output devices 914, 944, and one or more memory devices 916, 948. A processor 908, 940 may be any commercially available or customized processor and may include dual microprocessors and multi-processor architectures. A communication interface 910, 942, facilitates wired or wireless communications between the computing device 902, 904 and other devices. A storage device 912, 946 may be computer-readable medium that does not contain propagating signals, such as modulated data signals transmitted through a carrier wave. Examples of a storage device 912, 946 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 912, 946, in a computing device 902, 904. The input/output devices 914, 944 may include a keyboard, mouse, pen, voice input device, touch input device, display, speakers, printers, etc., and any combination thereof.

A memory device 916, 948 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 916, 948 may also include one or more external storage devices or remotely located storage devices that do not pertain to propagated signals, such as modulated data signals transmitted through a carrier wave.

The memory device 916, 948 may contain instructions, components, and data. A component is a software program that performs a specific function and is otherwise known as a module, program, component, and/or application. The memory device 916 may include an operating system 918, a source code repository 920, a code diff hunk generator 922, an intent classification model 924, a prompt generator 926, an encoder model configurator 928, a fine-tuning engine 930, a fine-tuning dataset 932, a pre-trained deep learning model 934, and other applications and data 936. Memory device 948 may include an operating system 950, a large language model 952, and other applications and data 954.

The computing devices 902, 904 may be communicatively coupled via a network 906. The network 906 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 906 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed pertain to the technical problem of reducing the burden on the user interface of a computing device. The technical features associated with addressing this problem is the detection of an intent of the source code changes made to a source code program and its inclusion into a prompt to the large language model. The technical effect achieved is the reduction of the number of prompts that a user makes, through the user interface, to obtain a useful and relevant code review comment thereby improving the user interface of the computing device.

Aspects of the subject matter disclosed herein pertain to the technical problem of automating code review comments for proposed code changes made to a source code program using a large learning model. The technical features associated with addressing this problem include the classification of the code changes with an intent that guides the model towards predicting relevant code review comments. The technical effect achieved is an improved accuracy of the predicted code review by the large language model.

The techniques described herein are an improvement over prior solutions that utilize a large language model to generate a code review without providing the model with the intent. The use of the intent in the prompt improves the accuracy of the predicted code review especially in situations where the large language model has not been trained for the code review generation task or for input not seen during training.

In addition, the techniques described herein utilize a pre-trained large language model without fine-tuning the large language model on the code comment generation task. Fine-tuning a large language model is a costly endeavor in time, resource consumption and expense that is avoided. Instead, the use of the intent in a prompt achieves comparable accuracy without an undue increased computational burden.

One of ordinary skill in the art understands that the techniques disclosed herein are inherently digital. The operations used to generate the intent classification model, to generate the prompt with its contents, and the use of the large language model to predict a code review are inherently digital. The human mind cannot interface directly with a CPU or network interface card, or other processor, or with RAM or other digital storage, to read or write the necessary data and perform the necessary operations disclosed herein.

The embodiments are also presumed to be capable of operating at scale, within tight timing constraints in production environments (e.g., version-control source code repository), and in testing labs for production environments as opposed to being mere thought experiments. Hence, the human mind cannot perform the operations described herein in a timely manner and with the accuracy required for these intended uses.

### CONCLUSION

A system is disclosed comprising: a processor; and a memory that stores at least one program that is configured to be executed by the processor. The at least one program includes instructions to perform actions that: obtain a first set of code changes made to a source code program; transform the first set of code changes into a code diff hunk; classify the code diff hunk with an intent that identifies a predicted problem with the first set of code changes; extract a file-level context and/or a repo-level context from the source code program; generate a prompt comprising the first set of code changes in the code diff hunk, the intent and the file-level context and/or the repo-level context; obtain at least one code review comment for the code diff hunk from a large language model given the prompt; and display the at least one code review comment in a user interface for selection.

In an aspect, the intent is based on historical code review comments for similar code changes as the first set of code changes. In an aspect, classify the first set of code changes with an intent that identifies a problem with the first set of code changes includes further instructions to perform actions that: apply the first set of code changes to a deep learning classifier model to predict the intent of the first set of code changes.

In an aspect, the deep learning classifier model is a neural encoder transformer model with attention. In an aspect, the large language model is a neural transformer with attention. In an aspect, the at least one program includes instructions to perform actions that: incorporate a natural language description of a task for the large language model to generate a code review comment in the prompt.

In an aspect, extract the file-level context and/or the repo-level context from the source code program includes further instructions to perform actions that: extract import statements, global attributes, signature of the class of the code change, methods that are adjacent to or directly invoked in area of the code change, and/or method signatures of other methods in the source code program.

In an aspect, the file-level context and/or the repo-level context from the source code program includes further instructions to perform actions that: extract method signatures used in the source code program that are defined in other files in a same repository.

A computer-implemented method is disclosed, comprising: obtaining a first set of code changes made to a source code program in a code diff hunk; classifying the code diff hunk with a select one of a plurality of labels, wherein the select label describes a problem with the first set of code changes; obtaining a file-level context from the source code program; creating a prompt comprising the code diff hunk, the intent and the extended context; obtaining, from a large language model given the prompt, at least one code review comment for the first set of code changes; and providing the at least one code review comment in a user interface for selection.

In an aspect, obtaining a first set of code changes made to a source code program in a code diff hunk further comprises: extracting the first set of code changes from a pull request for the source code program. In an aspect, classifying the code diff hunk with a label that describes a problem with the first set of code changes further comprises: applying the first set of code changes to a neural classifier to predict a likelihood of the first set of code changes associated with the select label.

In an aspect, the large language model comprises a pre-trained generative neural transformer model with attention. In an aspect, the plurality of labels is based on historical code review comments. In an aspect, the plurality of labels identifies issues with null pointer handling, code formatting, code refactoring, variable renaming, unit testing, configuration, file paths, checking or logic verification, exception handling and error logging, code cleanup, data, time and duration, static constants and import statements, string operations, and/or thread locking.

A hardware storage device is disclosed having stored thereon computer executable instructions that are structured to be executable by a processor of a computing device to thereby cause the computing device to perform actions that: pre-train a deep learning model having an encoder component and a decoder component on a plurality of code review tasks; obtain historical code changes having code review comments; cluster the historical code changes into groups, each group associated with a label that identifies a common problem with the historical code changes of the group; generate a fine-tuning dataset of code changes from the groups; fine-tune the encoder component of the pre-training deep learning model with the fine-tuning dataset to learn to classify an input set of code changes into a select one of the labels; deploy the encoder component to identify a first label for a first set of code changes applied to a source code program; generate at least one code review comment for the first set of code changes using a large language model given the first set of code changes and the first label; and display in a user interface the generated code review comments for selection.

In an aspect, each group is associated with a centroid, the centroid based on embeddings of the historical code changes of a group. In an aspect, the hardware device has stored thereon computer executable instructions that are structured to be executable by a processor of a computing device to thereby cause the computing device to perform actions that: obtain an unlabeled code review comment; generate an embedding for the unlabeled code review comment; and assign the unlabeled code review comment into a group having a centroid similar to the embedding of the unlabeled code review comment.

In an aspect, the encoder component comprises a neural encoder transformer with attention. In an aspect, the large language model is a pre-trained generative neural transformer model with attention. In an aspect, the plurality of code review tasks comprises denoising code diff samples, denoising review comment samples, diff tag prediction samples, and/or review comment generation samples.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

What is claimed:

1. A computer-implemented method for automated code review, said method comprising:
receiving code changes associated with a source code program;
generating a representation of the code changes configured for machine learning inference;
determining, using a trained neural model, an inferred intent associated with the code changes, the inferred intent characterizing a type of issue relevant to code review;
conditioning a code review comment generation process on the inferred intent and contextual information derived from the source code program;
generating, using a large language model, a code review comment for the code changes based on the conditioning; and
providing the code review comment for review by a developer.

2. The method of claim 1, wherein the contextual information comprises at least one of file-level context or repository-level context derived from the source code program.

3. The method of claim 2, wherein the file-level context comprises one or more of: import statements, global attributes, a class signature associated with the code changes, methods adjacent to the code changes, methods invoked by the code changes, or signatures of additional methods in a source code file containing the code changes.

4. The method of claim 2, wherein the repository-level context comprises method signatures defined in files different from a file containing the code changes and referenced by the source code program.

5. The method of claim 1, wherein generating the representation of the code changes comprises generating a code diff representation including indicators identifying added code, deleted code, and unchanged code.

6. The method of claim 5, wherein the indicators comprise special tokens replacing diff characters associated with the added code, deleted code, and unchanged code.

7. The method of claim 1, wherein determining the inferred intent comprises generating, by the trained neural model, a probability distribution across a plurality of candidate intents and selecting an intent having a highest probability.

8. The method of claim 1, wherein the trained neural model comprises an encoder portion of a pre-trained neural transformer model that has been fine-tuned to classify code changes according to code-review-related intents.

9. The method of claim 1, wherein the code changes are obtained from a pull request associated with a version-controlled source code repository.

10. The method of claim 1, wherein conditioning the code review comment generation process further comprises providing a natural language task description specifying one or more review objectives for generation of the code review comment.

11. The method of claim 1, wherein generating the code review comment comprises generating a plurality of candidate code review comments for the code changes.

12. The method of claim 11, further comprising presenting the plurality of candidate code review comments in a user interface and receiving a selection of one of the plurality of candidate code review comments.

13. The method of claim 12, further comprising incorporating the selected code review comment into a pull request associated with the code changes.

14. The method of claim 1, wherein deriving the contextual information comprises parsing a source code file containing the code changes into a syntax tree and identifying one or more syntax structures associated with a location of the code changes.

15. The method of claim 1, wherein the large language model is hosted on a remote computing system and generating the code review comment comprises transmitting information corresponding to the conditioning to the remote computing system through an application programming interface.

16. A computer system that automates code review, said computer system comprising:
a processor; and
a computer-readable hardware storage devices that stores instructions that are executable by the processor to cause the computer system to:
receive code changes associated with a source code program;
generate a representation of the code changes configured for machine learning inference;
determine, using a trained neural model, an inferred intent associated with the code changes, the inferred intent characterizing a type of issue relevant to code review;
condition a code review comment generation process on the inferred intent and contextual information derived from the source code program;
generate, using a large language model, a code review comment for the code changes based on the conditioning; and
provide the code review comment for review by a developer.

17. The computer system of claim 16, wherein the contextual information comprises at least one of file-level context or repository-level context derived from the source code program.

18. The computer system of claim 17, wherein the file-level context comprises one or more of: import statements, global attributes, a class signature associated with the code changes, methods adjacent to the code changes, methods invoked by the code changes, or signatures of additional methods in a source code file containing the code changes.

19. The computer system of claim 17, wherein the repository-level context comprises method signatures defined in files different from a file containing the code changes and referenced by the source code program.

20. The computer system of claim 16, wherein generating the representation of the code changes comprises generating a code diff representation including indicators identifying added code, deleted code, and unchanged code.
